(19) United States
(12) Patent Application Publication
(10) Pub. No.: US 2025/0241473 A1
(43) Pub. Date: Jul. 31, 2025

(54) BEVERAGE POD SYSTEM

(71) Applicant: SOCIETE DES PRODUITS NESTLE S.A., Vevey (CH)

(72) Inventors: LARRY LUKAS BURGE, Fischingen (CH); ARMIN GEMPERLE, Wil SG (CH); SILVIA QUATTRONE, Lausanne (CH); ARAMIA ASMAR, Yverdone-les-bains (CH); FREDERIC FRAGNIERE, Orbe (CH)

(21) Appl. No.: 18/855,024

(22) PCT Filed: Apr. 6, 2023
(86) PCT No.: PCT/EP2023/059143

§ 371 Date: Oct. 8, 2024

(30) Foreign Application Priority Data
Apr. 8, 2022 (EP) 22167453.4

(51) Int. Cl. A47J 31/36

(52) U.S. Cl. CPC A47J 31/3628; A47J 31/3633

(57) ABSTRACT

The invention concerns n extraction device for extracting a beverage ingredient from a pod (3) said device comprising upstream and downstream pod enclosing parts (1, 2) movable between an open position for inserting and removing the pod (3) and a closed position for forming an extraction chamber (5), and wherein, in the upstream pod enclosing part (1), the cage (21) comprises: —a side wall (211) movable between the open position and the closed position, and —an end wall (22) presenting a front face (22a) bearing piercing elements (222) and liquid outlet openings (223), said end wall (22) being movable inside the side wall (211), and wherein: —in the opened position for inserting and removing the pod (3), said end wall (22) is positioned at the opened front end (214) of the side wall, and is freely movable in direction of the back end (213)—in the course of the movement of the upstream enclosing part (2) from the opened position to the closed position, the free movement of the end wall (22) is automatically mechanically blocked when the chamber upstream enclosing part (2) reaches a pre-determined position.

### FIELD OF THE INVENTION

The present invention relates to the field of preparation of beverages with a system including a single-serve container comprising a beverage ingredient and a machine that has an extraction chamber in which the container can be inserted, extracted and from which it can be removed.

### BACKGROUND OF THE INVENTION

Single serve containers for the automatic preparation of beverages encompass various formats of containers that can be extracted according to different types of systems. In these systems, the container introduced by the user inside the system becomes enclosed in a chamber to perform the extraction process and then is removed from the chamber. The chamber comprises two parts configured to be moved apart during the introduction of the container and then moved one to the other to form the extraction chamber around the container for the beverage extraction.

Some of these systems are able to receive and extract containers of different sizes such as in WO 2020/089404. In such a machine, the two parts of the chamber can be moved one to the other to enclose the container by a motor. The movement of the motor is based on the identification of the size of the container introduced inside the system based on an identification of said size.

In order to reduce costs of manufacturing and energy used during beverage preparation, there is a need for a system that can handle containers of different sizes in an automatic manner and without the use of a motor.

An object of the invention is to address at least the above existing problems.

These problems are solved by the objects of claims 1 to 16.

### SUMMARY OF THE INVENTION

In a first aspect of the invention, there is provided an extraction device for extracting a beverage ingredient by supplying an extraction liquid into a pod:

The pod comprises:
a pod body that comprises:
   a side wall and a bottom wall defining a chamber, said chamber extending axially between the bottom and a top opening, and
a top lid closing the top opening of the pod body.

The extraction device comprises upstream and downstream pod enclosing parts wherein at least the upstream enclosing part is movable, preferably translatable, along a horizontal longitudinal axis (XX′) between an open position for inserting and removing the pod and a closed position for forming an extraction chamber enclosing the pod during extraction.

The upstream part defines a cage and comprises piercing elements for piercing the bottom wall of the pod and liquid outlet openings,

The downstream part defines a plate transverse to the longitudinal axis (XX′) and this plate comprises a downstream plane piercing arrangement for opening the lid of the pod.

The extraction device comprises a pod holder configured to hold the pod between the upstream and downstream pod enclosing parts when these parts are in the opened position. This holder is configured to hold the lid of the pod in front of the downstream plane piercing arrangement.

This pod holder can be positioned between the upstream and downstream enclosing parts in order to receive a pod inserted between the two enclosing parts positioned in the open position. Such a pod holder can be retracted and can make the pod free in order to be enclosed by the two enclosing parts when these parts are in the closed position. For example, WO 2005/004683 or WO 2007/134960 illustrate such types of pod holders.

In a preferred embodiment, this pod holder can be fully removable, detachable, from the extraction device and can be pinched between the two enclosing parts when these parts are in the closed position as detailed below.

In the upstream pod enclosing part, the cage comprises a side wall extending between an opened front end and a back end along a cage longitudinal axis, said side wall being movable between the open position and the closed position. Generally, the length of this side wall is greater than the biggest height of all the different pods that can be used in the extraction device.

The cage comprises an end wall transverse to said longitudinal axis of the cage. This end wall presents a front face and this front face bears the piercing elements and the liquid outlet openings. This end wall is movable inside the side wall. As a result, this end wall is able to adjust the internal volume of the cage with different depth sizes of pods.

The piercing elements of the upstream enclosing part rise from the surface of the front face by a piercing height.

In addition:
in the opened position for inserting and removing the pod, this end wall is positioned at the opened front end of the cage, and is freely movable in direction of the back end, and
in the course of the movement of the upstream enclosing part from the opened position to the closed position, the free movement of the end wall is mechanically blocked when the chamber upstream enclosing part reaches a pre-determined position.

Accordingly, when a pod is positioned between the two enclosing parts and these parts are closing, in a first part of this closing operation, the end wall is able to freely moves in the side wall as soon as the end wall contacts the pod and to adjust the internal volume of the cage with the depth size of the pod. Then, in a first part of this closing operation that is when the upstream enclosing part reaches the pre-determined position, the movement of the end wall is automatically mechanically blocked. As a result, during the last part of the course of the movement of the upstream enclosing part, the piercing elements of the upstream enclosing parts rising from the surface of the front face of the end wall are able to pierce the pod.

Generally, this pre-determined position of the upstream enclosing part (where the end wall becomes blocked) is intermediate between the opened position and the closed position of the upstream enclosing part.

Preferably, this pre-determined position of the upstream enclosing part is defined so that, when the chamber upstream enclosing part reaches the pre-determined position, the piercing elements abut on the surface of the pod.

Accordingly, these piercing elements are well positioned to pierce optimally the bottom wall of the pod in the last part of the course of the upstream enclosing part.

Preferably, the end wall comprises a rod extending from a back face of the end wall and this rod is mechanically blocked, preferably able to be clamped, when the chamber upstream enclosing part reaches the pre-determined position.

In one preferred embodiment, the rod can be mechanical blocked by jaw means able to clamp around the rod.

Preferably, the operation of clamping of the jaw means can be configured to be triggered by a lever, that is actuated by the movement of the upstream enclosing part, in particular when said part reaches the pre-determined position.

In one preferred embodiment, the lever can be attached to the movable chassis of the upstream enclosing part and configured to be retained and rocked by a fixed part of the extraction device, such as the fixed chassis of the extraction device.

Preferably the front face of the end wall of the cage bears a pin extending from the surface of the front face by a pin height that is at least greater than the piercing height of the piercing elements, and this pin is retractable inside the end wall.

This pin provides the interaction between the surface of the bottom of the pod and the end wall and enables the adjustment of the internal volume of the cage before the end wall is mechanically blocked.

This pin is retractable so that once the end wall is blocked and the closed position of enclosing parts is reached, then the piercing is enabled.

Preferably, when the chamber upstream enclosing part reaches the pre-determined position, the distance between the two enclosing parts to form the extraction chamber corresponds to the height of the pin extending from the surface of the front face of the end wall.

Accordingly, this last distance enables the formation of the extraction chamber and the piercing of the bottom wall.

In the preferred embodiment, the extraction device comprises:
a removable pod holder, said holder comprising a pod receiving hole to receive and hold the pod,
a top insertion section configured for introducing the pod holder in the device. This top insertion section comprises a path for guiding the pod holder to the extraction area between the enclosing parts and for positioning the lid of the pod in front of the downstream enclosing part.

In addition, in their closed position, the upstream and downstream pod enclosing parts enclose the pod holder.

This removable pod holder provides the effect of holding the pod inside the extraction chamber during the extraction operation. Consequently, there is no need to provide the chamber with additional and complex pod holders to receive the pod and eject the pod. The concept of the chamber can remain simple and is less costly.

The pod holder can be introduced inside the extraction device and removed from it manually saving costs of manufacture and of use.

The pod holder, that can be manipulated manually, enables the concept of beverage machine that is deprived of bin and means to move the pod to the bin after preparation. The machine is smaller and less costly.

Preferably, this pod holder is fully removable from the extraction device. The user can easily introduce the pod inside the holder when the pod holder is outside the extraction device; the user can easily carry the pod holder in the holder to the bin after extraction.

Usually, the top insertion section is configured to introduce the holder along a vertical direction from the top of the device, and the pod receiving hole and the top insertion section are configured to position the lid of the pod vertically when the removable pod holder is positioned inside the device.

Preferably, the pod holder comprises orientation means to orientate the pod correctly inside the holder and then inside the extraction device, in particular in view of the downstream or upstream parts depending on the construction of the pod.

In one preferred embodiment, orientation means are configured to orientate the lid of the pod so at that it faces either the downstream or upstream part, depending on the construction of the pod.

Such orientation means can be a specific design of the holder and of the insertion path of the extraction device urging the user to position the pod and the pod holder in one manner only.

Preferably, the relative movement of the upstream and downstream enclosing parts is linear. It is preferably a translation. Preferably, the introduction and removal of the pod holder is linear too and preferably perpendicular to the linear movement of the enclosing parts.

As a result, the dimension of the extraction device can be kept small.

Generally, the holder and its hole are designed so that once the pod is positioned in the hole, at least a part of the lid and at least a part of the bottom of the pod is not covered or enclosed by the pod holder and remains accessible for being pierced by the downstream and upstream pod enclosing parts during the beverage preparation. In addition, the hole is designed to receive different pods differing by their depth sizes, in particular differing by the heights of the side wall. Accordingly, it is preferable that the hole is configured to not cover at all the bottom wall of the pod.

Preferably, the whole surfaces of the lid and the pod body bottom are uncovered by the holder. Accordingly, these parts remain fully accessible by the piecing elements of the extraction device.

In one preferred embodiment, the top insertion section comprises a path for guiding the pod holder to the extraction area between the upstream and downstream pod enclosing parts, and the extraction device comprises a holder stopper to stop the pod holder in an intermediate temporary position inside said path.

This intermediate temporary position can be configured to enable the user to load the extraction device with the pod holder before the holder is further displaced automatically to the brewing chamber formed by the upstream and downstream enclosing parts.

The intermediate position can avoid any manual wrong, incorrect introduction in the core part of the extraction device.

In one preferred embodiment, the extraction device can comprise a recognition device configured to recognise or identify a pod hold in the pod holder when the pod holder is in the intermediate temporary position. This intermediate position of the holder enables recognition step, for example by an optical reader in order to:
provide the process control unit of the extraction device with information related to the beverage preparation (authorised pod, optimal recipe), or
stop the preparation if a defect is identified (already extracted pod that was not removed from the holder) and alert the user through a display. The user can immediately remove the holder and check the pod in the holder.

Preferably, the extraction device comprises an actuator to move the pod holder to the extraction area between the upstream and downstream pod enclosing parts. This actuating means is preferably manually actuated, like a handle. As a result, the machine can be manually operated directly, when loading the pod with the pod holder, and indirectly with the handle moving the pod holder to the extraction area.

Preferably this actuator is cinematically linked to:
the holder stopper so that said stopper is configured to drive the pod holder between the intermediate position and the extraction area when said actuator is operated, and
at least the upstream enclosing part to move said part between the open position and the closed position.

The actuating means can be configured to coordinate the relative movement of the upstream and downstream parts and the movement of the pod holder so that:
the pod holder is positioned in the extraction area between the two enclosing parts before these parts enclose the pod, and
at least one, preferably both, enclosing parts are moved away from the pod before the pod holder is removed from the extraction area.

Preferably, each of the downstream and upstream parts are movable between a respective open position for inserting and removing the pod holder and a respective closed position for forming an extraction chamber that encloses the pod holder during extraction.

The movements of each of the upstream and enclosing parts to and away from the pod are preferred because frequently, further to the beverage extraction, a part of the lid or of the bottom of the pod body can remain engaged with the piercing elements rising from said parts.

The movements of these enclosing parts enable the disengagement from the pod and a safe removal of the pod holder.

Preferably, the actuating means is configured to move each of the upstream and downstream parts between the open position and the closed position of said parts.

Preferably, when the pod holder is in the extraction area and the upstream and downstream enclosing parts are in the closed position, the surround of the receiving hole of the pod holder is pinched between the upstream and downstream enclosing parts.

Preferably, the pod holder comprises a plate and this plate comprises the hole for receiving the pod, said plate comprising a front face and a back face. In addition, the pod holder comprises a seal, that covers all the front face and back face of the surround of the receiving hole of the pod holder.

Accordingly, the holder participates to the tightness of the extraction chamber during the beverage preparation.

In a second aspect of the invention, there is provided a beverage preparation machine comprising an extraction device such as described above.

Generally, this beverage machine comprises a liquid supply system connected to the upstream enclosing part. This liquid supply system can comprise:
a liquid supply such as a liquid tank,
pumping means to drive liquid form the liquid supply to the extraction device,
heating and/or cooling means to adapt the temperature of the liquid before it is introduced inside the pod.

The liquid is usually water.

Usually, this beverage machine comprises a control unit configured to control at least the supply of liquid to the extraction device. The control unit can be configured to control the recognition operation of the recognition device if present or to display information to the user.

In a third aspect of the invention, there is provided a system comprising an extraction device such as described above and pods of different depth sizes or a beverage preparation machine such as described above and pods of different depth sizes, wherein each of said pod comprises:
a pod body, said pod body comprising a side wall and a bottom wall defining a chamber, and
a top lid closing the top opening of the pod body, and
wherein said pods differ by the depth sizes of the side walls.

In a fourth aspect, there is provided the use of a set of different pods, said pods differing by the depth sizes of the side walls, in the extraction device such as described above or in a beverage machine such as described above or in a system such as described above.

In the present application:
the term “pod” is used to broadly designate any kind of single-dose container suitable for preparing beverages or other edible products such as capsules, cartridges, portioned or individual packages without limitation to the shape of this container, the material this container is made of or the types of piercing means needed to extract the beverage therefrom.
the term “longitudinally” refers to the orientation of the two enclosing parts one to the other and their movement along the longitudinal axis XX′.
the term “vertically”, “upwardly” and “downwardly” refers to the movement of the pod in the extraction device from its introduction between the two enclosing parts and its removal therefrom. The terms “upper” and “lower” refer to this vertical axis too.
the terms “upstream” and “downstream” refer to the path of liquid through the extraction device from the upstream enclosing part to the downstream enclosing part.

Generally, these terms are used to describe the relational positioning of features of the extraction device. These terms should be understood to refer to said device in its normal orientation when positioned in a beverage machine for the production of a beverage as shown in the FIGS. 2A, 2E, and 4A to 4H.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

Specific embodiments of the invention are now described further, by way of example, with reference to the following drawings in which:

FIGS. 1A to 1C are different perspective view of pods used in the extraction device of the present invention,

FIGS. 2A and 2D are side and top views respectively of an extraction device according to the invention the pod holder being removed therefrom,

FIGS. 2B and 2C are perspective views of some isolated parts of said extraction device of FIG. 2A,

FIG. 2E is a side view of the extraction device of FIG. 2A with the pod holder enclosed inside and FIG. 2F is side view of some isolated parts of said extraction device of FIG. 2E,

FIG. 2G is a perspective view of the upstream enclosing part isolated from the extraction device of FIG. 2F,

FIGS. 2G and 21 are isolated views of the upstream enclosing part from the FIGS. 2B and 2F respectively,

FIGS. 2H and 2J are cross section views of FIGS. 2G and 21 respectively,

FIGS. 2K and 2L are isolated views of the mechanism for blocking the movement of the end plate,

FIG. 3A is a front view of the holder holding a pod,

FIG. 3B is a back view of the holder holding a pod,

FIG. 3C is perspective view of the holder without any pod,

FIG. 3D is a bottom view of the holder holding a pod,

FIGS. 4A-4H are cross section views illustrating the steps of movement of the two enclosing parts from the opened position to the closed position,

FIG. 5A-5C are cross section views illustrating the steps of introduction of a pod holder in the extraction device,

FIG. 6 illustrates the fluid system of the extraction device.

### DETAILED DESCRIPTION OF EXEMPLARY EMBODIMENTS

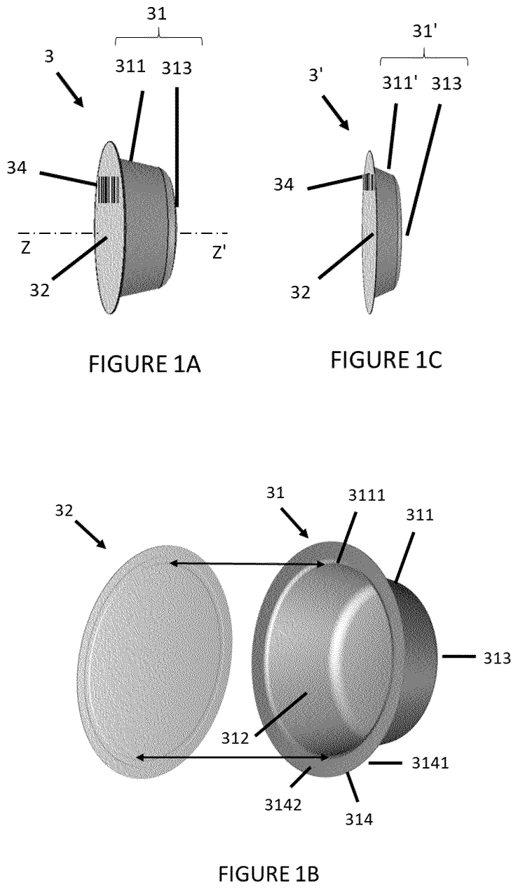

FIGS. 1A (perspective view) and 1B (exploded view) illustrate the pods 3, 3′ that can be used in the extraction device of the invention.

FIGS. 1A (perspective view) and 1B (exploded view) illustrate a pod 3 that can be used in the extraction device of the invention.

The pod 3 comprises a pod body 31 with one side wall 311 that extends axially from a bottom wall 313 towards a top. The side wall 311 extends towards a top opening 312. At the top opening 312, the body comprises a circumferential annular flange 314 that extends radially outward from the side wall 311 along the circumference of the opening 312.

The flange comprises an upper surface 3142 facing the top and a lower surface 3141.

Generally, any transversal cross section of the body is circular from the bottom to the top and the flange is circular too.

The body delimits a chamber for containing a beverage ingredient.

This beverage ingredient is preferably an ingredient able to be extracted like roast and ground coffee.

In a less preferred manner, the beverage ingredient can be tea leaves or a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate. The powders can be agglomerated or sintered.

The capsule comprises a lid 32 that is fixed, sealed or attached to at least a part of the upper surface 3142 of the circumferential flange and accordingly covers and closes the top opening 312.

A machine-readable code 34 can be arranged on the lid. This code can provide different types of information such as:
the nature of the beverage ingredient,
the depth size of the pod,
authorised pod,
the extraction recipe to applied to the pod: temperature of the fluid, volume of the fluid, flow of the fluid.

The bottom wall 313 is adapted to be pierced so that liquid can be injected in the pod through the pierced openings.

The lid 32 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid and the flange.

FIG. 1C illustrates another pod 3′ that can be used in the extraction device of the invention and differ from the pod 3 of FIG. 1A only by the depth size (along axis ZZ′) of the pod bodies 31′. The pod body 31 of the big pod 3 defines an ingredient chamber with a bigger volume than the pod body 31′ of the small pod 3′, the side wall 311 being higher than the side wall 311′. The diameter of the lids 32, 32′ of the small and big pods are identical.

This difference in sizes enable the preparation of different beverages, preferably different coffee beverages like ristretto, espresso, lungo (long cups), americano, . . .

Other sizes than those illustrated can be provided, like an intermediate size.

The machine-readable code 34 can store information about the size of the pod.

The extraction device of the present invention can be configured for using alternative containers to those described above as soon as they comprise a body defining a chamber and a lid to close the chamber. The two enclosing parts just needs to present internal shapes conformal to the containers.

For example, the container can be a frusto-conical capsule made of aluminum or plastic.

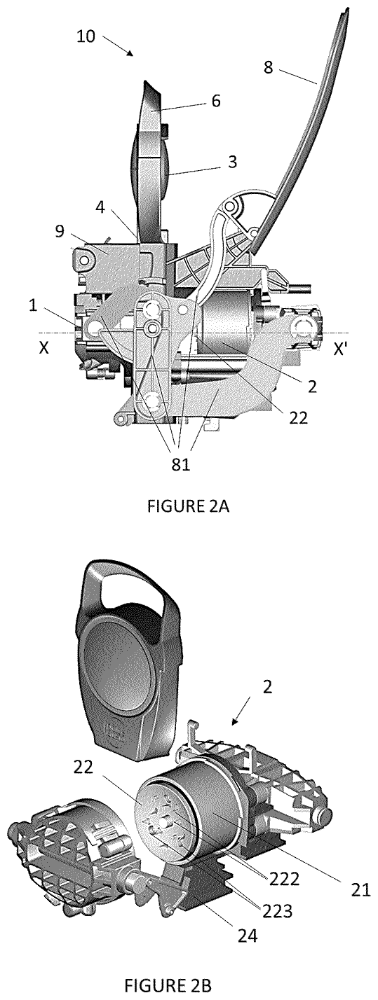

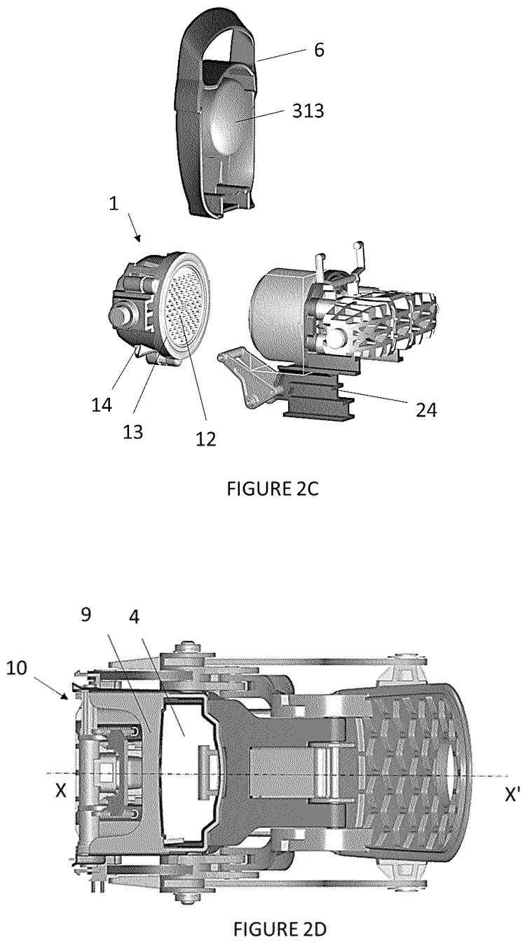

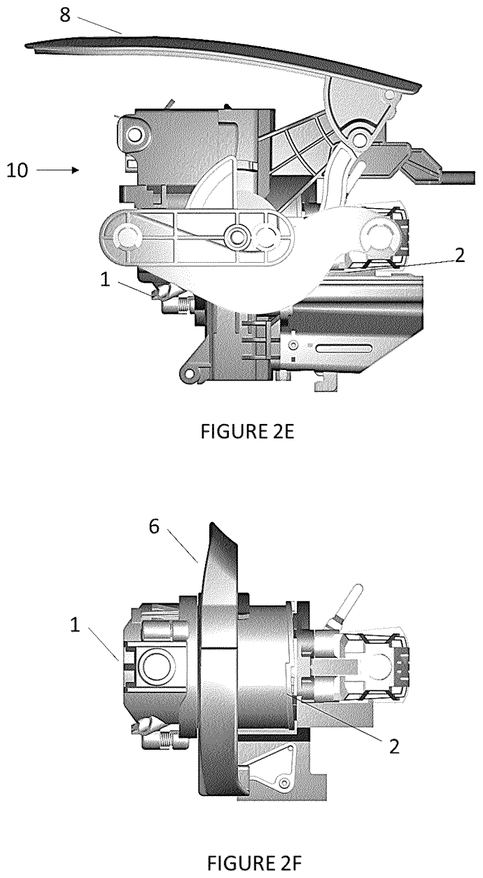

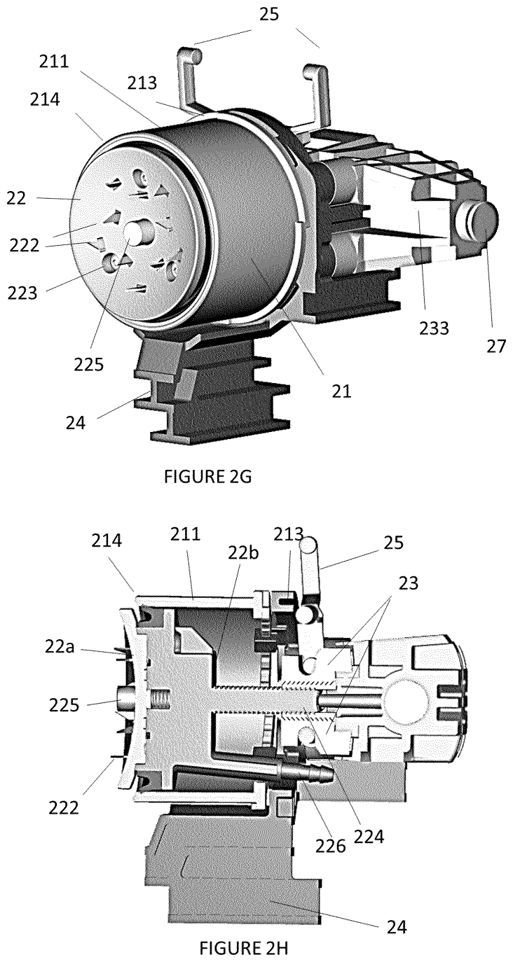

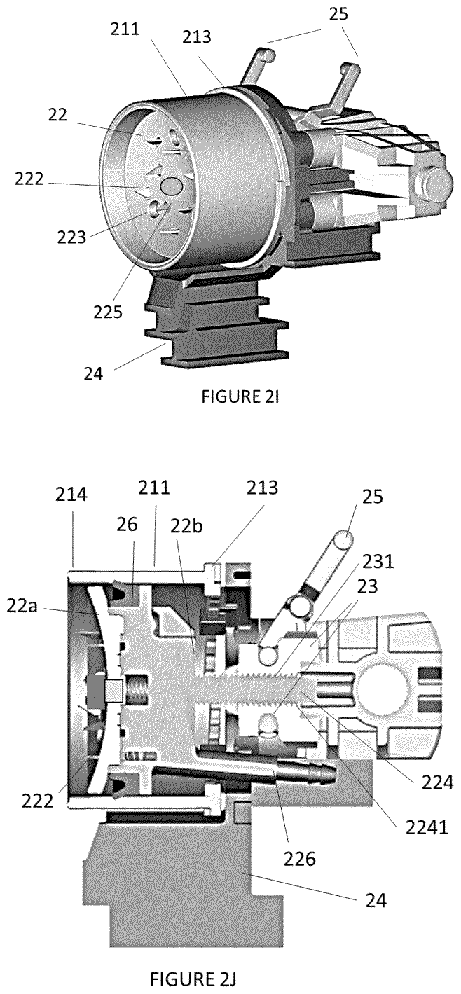

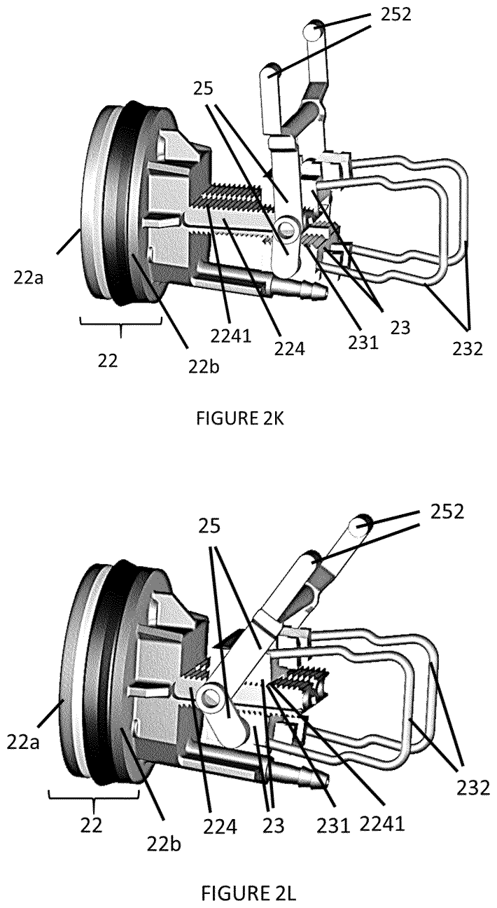

FIG. 2A is a side view of an extraction device 10 according to the invention comprising an upstream pod enclosing part 2 and a downstream pod enclosing part 1 relatively translatable along a longitudinal axis XX′. Usually, this axis XX′ is essentially horizontal. In FIG. 2A, these two parts are in an opened position configured to receive a pod for extraction. These two enclosing parts are supported by a chassis 9 and made movable from said opened position to a closed position by actuating a handle 8 connected to these enclosing parts by a system 81 of interrelated knee levers.

In this particular embodiment, the device comprises a pod holder 6 that holds a pod 3. This holder is fully removable from the extraction device and is illustrated in FIG. 2A outside the chassis where it is ready for an operation of introduction between the enclosing parts or at the end of said operation during the removal of the extracted pod form the extraction device. The pod is introduced through an insertion section 4 positioned above the two enclosing parts 1, 2.

In other embodiments, the pod can be introduced without the use of a removable pod holder; for example, the pod can be introduced directly inside the insertion section and the downstream part 1 positioned below the path 41 can comprise local pod holders to hold the pod between the two enclosing parts.

FIGS. 2B and 2C are perspective and isolated view of the two pod enclosing parts 1, 2 and the pod holder 6 in the position illustrated in FIG. 2A.

The downstream part 1 comprises a plate perpendicular (that is transverse) to the longitudinal axis XX′. This plate comprises a central downstream plane piercing arrangement 12 for opening the lid 32 of the pod when the extracting liquid is introduced inside the pod and inflates the lid.

Usually, this central downstream plane piercing arrangement 12 is circular like the lid of the pod.

Opening happens by relative engagement of spikes with the lid under the effect of the rise in pressure of the injected liquid in the pod body chamber. This downstream plane piercing arrangement may comprise a rigid plate comprising opening elements 121 such as spikes, that can present the shape of cones or pyramids, optionally truncated at their ends, on its surface turned to the lid. In addition, the plate comprises traversing holes to evacuate the beverage dispensed from the opened lid to a beverage outlet 14, such as a tube or nozzle collecting and dispensing beverage to a drinking cup.

The plate comprises a peripheral area 13 surrounding that piercing arrangement 12.

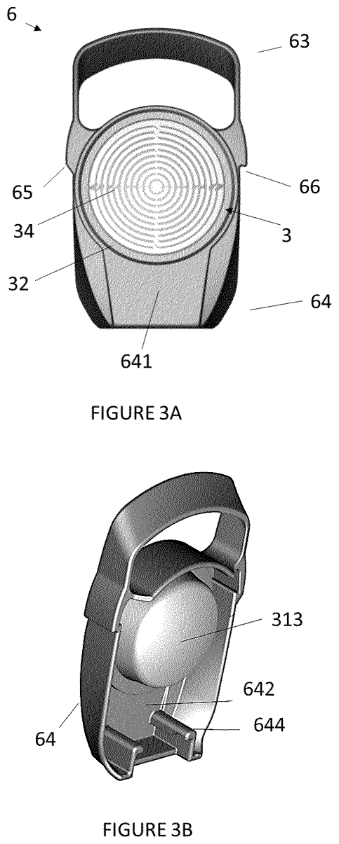

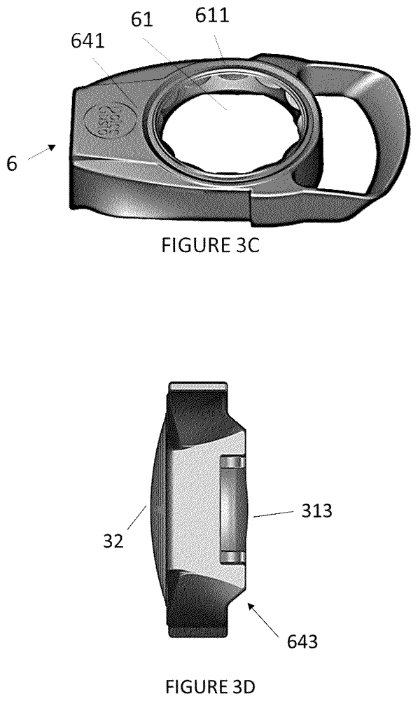

The upstream part 2 defines a cage 21 or cavity for enclosing the pod body. This cage presents an adjustable internal volume as detailed below in FIGS. 3A-3D

The top view of the extraction device in FIG. 2D shows the insertion section 4 for the pod holder that is provided in the chassis 9. This insertion section 4 is designed to enable the introduction of the pod holder 6 so that the lid 32 of the pod hold in the holder is positioned in front the of the downstream enclosing part 1.

This view makes apparent that the extraction device can comprise a code reader 7 positioned aside the insertion section and above the two enclosing parts 1, 2 and configured to read a code on a capsule positioned in the insertion section.

FIGS. 2E and 2F illustrate the extraction device of FIGS. 2A-2C wherein the pod 3 is enclosed between the two enclosing parts 1, 2.

In the specific illustrated embodiment, where the pod is hold by the pod holder 6, this pod holder 6 is positioned between the upstream pod enclosing part 2 and the downstream pod enclosing part 1 and these two parts have been moved one to the other by actuation of the interrelated levers by the handle 8. In this position, the pod holder 6 is firmly pinched between the two enclosing parts 1, 2.

FIG. 2G shows the upstream enclosing part 2 of FIG. 2B isolated from the other elements. The upstream part 2 is supported by a movable carrier 24 that enables its movement along the axis XX′.

The upstream part 2 defines a cage 21 or cavity for enclosing the pod body. This cage presents an adjustable internal volume as explained below. A movable end wall 22 transverse to the longitudinal axis XX′ of the cage enables this adjustment. This end wall 22 bears piercing elements 222 for opening the bottom wall 313 of the pod body and liquid outlet openings 223 for supplying liquid into the pod through the holes opened in the bottom wall of the pod. These piercing elements can comprise piercers in the form of blades. These blades can be designed and positioned to pierce the wall of the bottom of the pod body when the upstream and downstream pod enclosing parts are brought to the closed position. The liquid outlet openings 223 can form a shower at the upstream wall of the cage and the supplied liquid can be introduced in the pod through the pre-pierced openings. A liquid inlet 226 provided at the back side 22b of the end wall 22 supplies that fluid.

Since pods 2 of different depth sizes can be introduced and extracted, the end wall 22 of the cage can be made movable to adapt the cage internal volume to the pod. When the two enclosing parts 1, 2 are in the opened position, this end wall 22 is positioned at the opened front end 214 of the side wall.

When a pod is introduced in the extraction device and the two enclosing parts 1, 2 are in the closed position, this end wall 22 is freely moved by the pod in direction of the back end 213 of the side wall as illustrated in FIG. 21.

FIGS. 2H and 2J are cross section views of FIGS. 2G and 21 respectively illustrating the movement of the end wall 22.

The end wall 22 comprises a rod 224 that extends from its back face 22b. This rod 224 of the end wall is free to move when the enclosing part starts moving from the opened position to the closed position. Accordingly, during this movement, the bottom wall of a pod positioned between the two opened enclosing parts becomes contacted by the pin 225 rising from the front end 22a of the front wall and this bottom wall pushes back the end wall inside the side wall 211 and in direction of the back end 213.

At one pre-set position of the upstream part 2 during its movement from the opened position to the enclosed position, the rod 224 of the end wall is mechanically blocked and the relative position of the end wall 22 and the side wall 21 is fixed during the last part of the closing movement.

In the illustrated embodiment, the surface of the rod 224 extending from the back face 22b of the end wall comprises teeth 2241 that can be engaged with corresponding teeth 231 of jaws configured to clamp the rod 23 when the pre-set position is reached.

The movement of the jaws 23 can be actuated by a knee lever 25, which is himself controlled by the movement of the upstream enclosing parts as detailed below in FIGS. 2K and 2L.

FIGS. 2K and 2L are isolated views of the mechanism for blocking the movement of the end plate 22.

The rod 224 is a longitudinal piece extending upstream from the back face of the end wall and presenting teeth 2241 at its upper and lower surfaces.

Upper and lower parts of jaws 23 face these toothed surfaces. The surface of these jaws present teeth 231 configured to be able to engage with the teeth 2241 of the rod.

The relative movement of these two jaws 23 and the rod 224 is controlled by a knee lever 25 that is configured to move the jaws away or in contact with the rod depending on its position.

In FIG. 2K, the knee lever 25 positions the two jaws 23 away from the rod 224 and the end wall 22 is free to move in the side wall of the upstream enclosing part.

In FIG. 2L, the knee lever 25 closes the two jaws 23 around the rod 224 so that the teeth 2241, 231 are engaged and the end wall 22 is blocked in the side wall of the upstream enclosing part.

Two knee lever springs 232 helps the movement of the jaws from the clamping position to the free position.

The knee lever presents a free end 252 that enable the control of the movement of this lever: by pulling or pushing this end 252, the jaws are clamped on the rod or positioned away from the rod.

FIGS. 3A-3C illustrate a pod holder that can be used in the specific illustrated extraction device. As already mentioned, extraction devices according to the invention can be implemented without such a pod holder.

FIG. 3A is a front view of the pod holder 6 holding a pod 3 and showing the front face 641 of the pod holder on which the lid 32 of the pod is positioned. FIG. 3B shows the back face 642 of the pod holder on which the bottom 313 of the pod emerges. FIG. 3C is a perspective view of the holder without any pod.

In its front face 641, the pod holder 6 presents a hole 61 configured through which the body 31 of the pod can be received. The holder and its hole are designed so that once the pod 3 is positioned in the hole 61, at least a part of the lid 32 and at least a part of the bottom 313 of the pod is not covered or enclosed by the pod holder and remains accessible for code reading and for being pierced by the downstream and upstream pod enclosing parts during the beverage preparation.

In the particular above illustrated embodiment, a code 34 is provided on the whole surface of the lid and can be read from whatever part of said lid by the code reader.

In addition, in the particular above illustrated embodiment of the extraction device, the piercing elements 12, 222 of the downstream and upstream enclosing parts are configured to pierce large surfaces of the lid 32 and of the pod bottom 313; accordingly, the holder does not comprise any shell that covers the bottom of the pod body: the bottom remains uncovered and accessible for piercing. Accordingly, pods with different heights of bodies can be received and hold in the pod holder, for example the pods 3 or 3′ illustrated in FIGS. 1A and 1C.

In the illustrated embodiment, the holder can comprise some retaining elements at the internal surround of the hole. These retaining elements, such as the illustrated short flexible tongues 612, can maintain the pod inside the holder by friction when the pod holder is manipulated by the user and is introduced vertically inside the insertion section.

A handle 63 facilitates the handling by the user, in particular by urging the user to orientate the holder with the handle positioned upwardly during the introduction of the pod holder in the insertion section, that is with the lid 32 in front of the downstream part 1 and the pod bottom 313 in form of the upstream part 2.

As illustrated in FIG. 3D, the shape of the bottom 643 of the pod holder is asymmetric. This asymmetric shape is identical to the shape of the insertion section 4 so that the user is urged to position the pod correctly between the upstream and enclosing parts as mentioned above in relation with FIG. 2D.

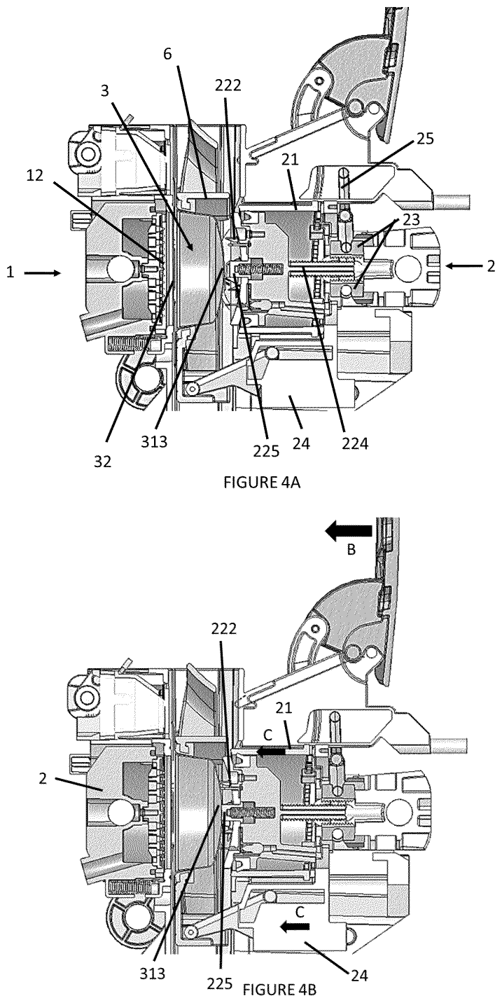

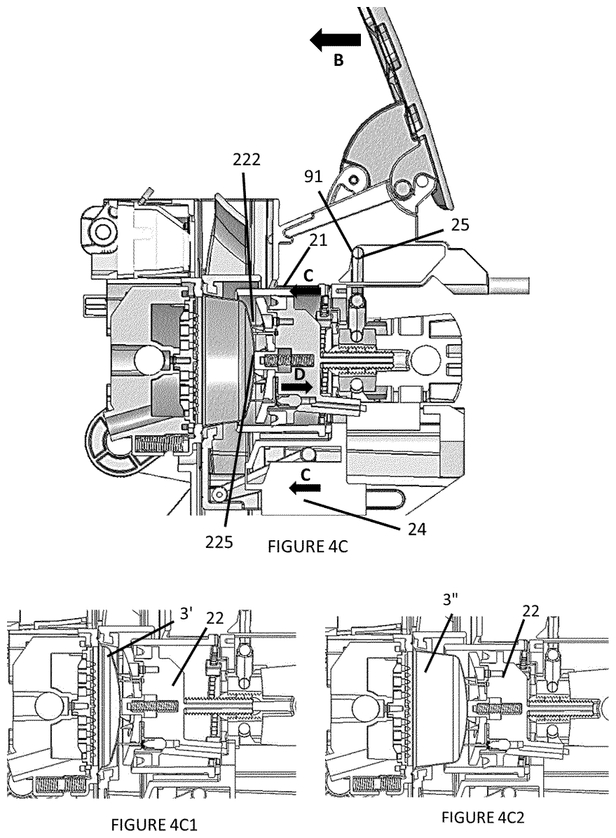

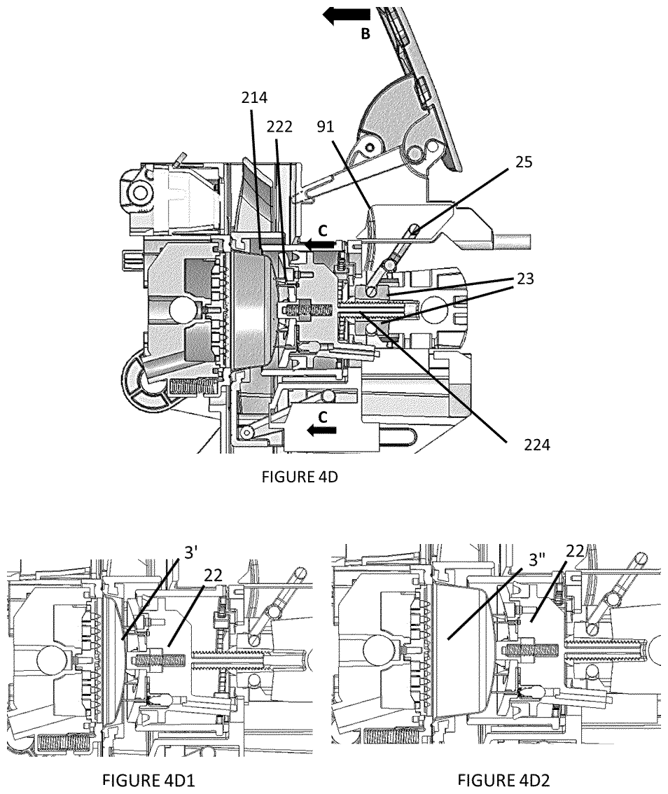

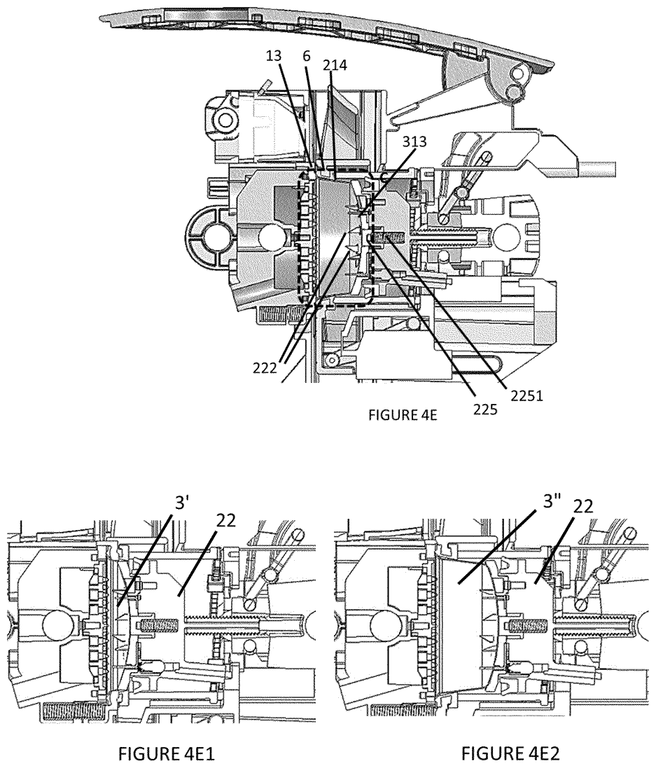

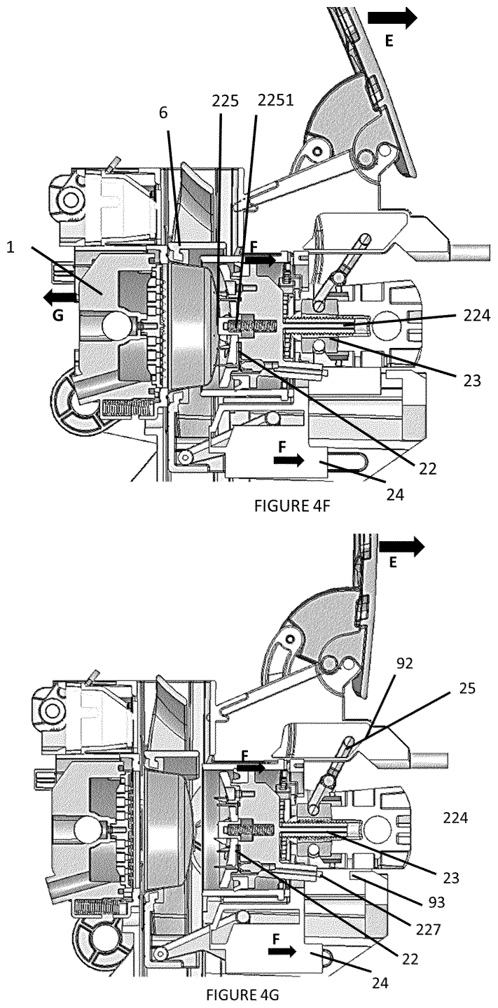

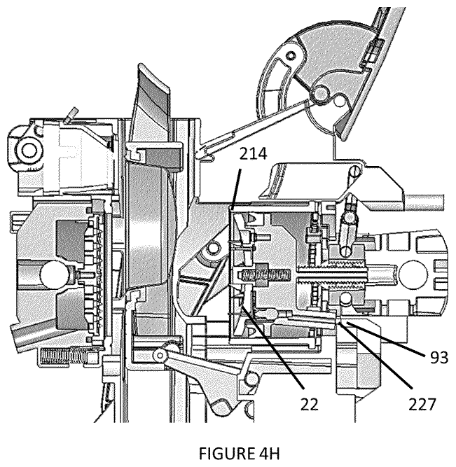

FIGS. 4A-4H illustrate the movement of the two enclosing parts 1, 2 during a beverage preparation.

In FIG. 4A:
the pod holder 6 holding the pod 3 was introduced between the two enclosing parts 1, 2 and positions the pod 3 between these two parts in the opened position. The pod holder 6 is well aligned between the two enclosing parts 1, 2 and along the longitudinal axis XX′.
the lid 32 of the pod is positioned away the downstream plate piercing arrangement 12,
the bottom wall 313 of the pod is positioned away the piercing elements 222 of the upstream end wall 12 and the pin 225,
the rod 224 at the back face of the end wall is not clamped by the jaws 23 and accordingly the end wall 22 is free to move inside the side wall 21.

In FIG. 4B:
the user moves the handle 8 to its closed position as illustrated by arrow B.
due to the system 81 of interrelated knew levers between the handle 8 and the carrier 24 of the upstream enclosing part 2, this upstream part starts moving in direction of the downstream part 1 as illustrated by arrow C. In this preferred illustrated embodiment, the downstream pod enclosing part 2 is moving too in direction of the upstream part 1.
the carrier 24 drives all the assembly of the downstream enclosing parts including the piercing elements 222 of the upstream end wall 12 and the pin 225, which, at this step, reach and contact the bottom 313 of the pod. The pin 225 is configured to rise above the surface of the front face 22a of the end wall by a height h that is at least equal to the height by which the piercing elements 222 rise above the same surface. Consequently, the pin 225 prevents the piercing of the pod at this stage of the movement of the enclosing parts 1, 2. The pin 225 forms the interface between the bottom of the pod and the end wall 22.

In FIG. 4C:
the handle 8 goes on closing and the carrier 24 of the upstream enclosing part 1 goes on moving to the whole downstream part 1 as illustrated by arrow C. In particular, the lever 25 of the jaw 23 has almost reached an abutment wall 91 that is part of the chassis 9 of the extraction device.
as the pod 3 prevents the end wall from moving more in direction of the downstream part, the bottom of the pod pushes the pin 225 and the end wall 22 which slides freely inside the side wall 21 as illustrated by the arrow D.

FIGS. 4C1 and 4C2 show the similar position of the two enclosing parts when a smaller pod 3′ and a bigger pod 3″ are introduced in the extraction device. It can be observed that the movement of the end wall 22 adapts to the depth size of the pod.

In FIG. 4D:
the handle 8 goes on closing and the carrier 24 of the upstream enclosing part 1 goes on moving to the whole downstream part 1 as illustrated by arrow C. The lever 25 of the jaw 23 was just retained by the abutment wall 91 and immediately rocked with the effect of clamping the jaws 23 around the rod 224 of the end wall. As a result, the movement of the end 22 inside the side wall 21 is stopped and the size of the extraction cage is set for the depth size of the pod that was introduced inside the extraction device.
yet the extraction chamber is not yet closed since the front end 214 of the side wall has not yet reached the downstream part 2. At that step, the last distance to be covered by the upstream enclosing parts to close the chamber enables simultaneously the closure of the extracting chamber and the piercing of the bottom of the pod.

FIGS. 4D1 and 4D2 show the similar position of the two enclosing parts with the smaller pod 3′ and the bigger pod 3″. It can be observed that at the same pre-determined position of the carrier 24 the end wall 22 becomes blocked, yet its relative position in the side wall 21 is adapted to each size of the pod.

In FIG. 4E:
the handle 8 has reached its closing position and covers the path 41 of the insertion section.
the downstream and upstream enclosing parts 1, 2 and the holder 6 form an extraction chamber 5 (in dotted line) that encloses the pod 3.
since the end wall 22 of the upstream enclosing part was fixed, the piercing elements 222 were able to pierce the bottom 313 of the pod while the chamber is being closed. The pin 225 is retractable inside the end wall 22 due to the presence of a spring 2251.

FIGS. 4D1 and 4D2 show the similar position of the two enclosing parts with the smaller pod 3′ and the bigger pod 3″. It can be observed that whatever the depth size of the pod, the bottom wall is correctly pierced by the piercing elements 222.

The preparation of the beverage can start by introducing liquid through the liquid outlets 223 of the upstream enclosing part.

FIGS. 4F-4H illustrate the steps of removal of the pod holder from the extraction device after the extraction operation of FIG. 4E.

These steps happen while the user pulls the handle 8 to open the extraction device and movements exactly opposed to those described in FIGS. 4C to 4E happen.

In FIG. 4F, the user starts pulling upwardly the handle as illustrated by arrow E with the effect that the carrier 24 of the upstream enclosing part 2 moves away from the pod holder 6 and the downstream part 2 as illustrated by the arrow F.

Since the jaws 23 still clamps the rod 224, the movement of the side wall 21 drives simultaneously the movement of the end wall 22 and the piercing elements 222 can be pulled out of the bottom of the pod.

The spring 2251 pushed the pin 225 that can help the removal of the piercing elements 222 from the bottom 313 of the pod.

In FIG. 4G, the user goes on pulling the handle 8. The lever 25 of the jaw 23 is rocked back by another abutment wall 92 with the effect of making the rod 224 of the end wall free from the jaws 23. As a result, while the side wall goes on back along the direction of the arrow F, the end wall 22 remains immobile within that side wall 21 and follows the movement of the side wall.

The back face 22b of the end wall comprises a projection 227 that is designed to engage with an abutment wall 93 of the chassis of the device at the end of the movement in the direction of arrow F

In FIG. 4H, the handle 8 is fully opened and both enclosing parts 1, 2 have reached their most distanced positions. The projection 227 has engaged the abutment wall 93 of the chassis of the device with the result that the end wall 22, which is free to move inside the side wall 21, has been moved to the front end 214 of the side wall.

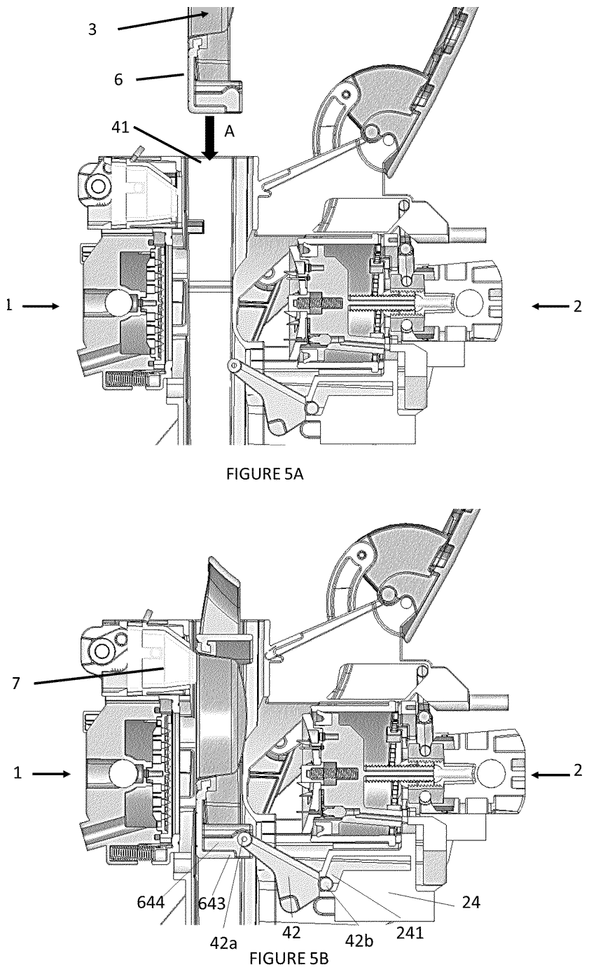

FIGS. 5A to 5D illustrate the steps of introduction of the pod holder 6 in the extraction device before the pod is positioned in the extraction device as illustrated in FIG. 4A.

In FIG. 5A:
the handle 8 is in the open position where:
   it does not cover the insertion section 4, and
   it positions the two enclosing parts 1, 2 away one from the other
the pod holder 6 was loaded with a pod 3 and is positioned above the insertion section 4: it is slidden vertically inside the path 41 as illustrated by the arrow A.

In FIG. 5B:
the pod holder 6 was introduced in the path by the user and is stopped in an intermediate temporary position inside the path 41 by a stopper 42 on which the pod holder abuts. A downstream end 42a of this stopper 42 is configured to be positioned inside the path 41 when the handle 8 is in the open position so as to interact with the bottom 643 of the pod holder and to stop its downwards sliding movement operated by the user.

This intermediate position can enable an operation of identification or recognition of the pod by a recognition device 7 positioned in that part of the path 41 before the pod is introduced further between the enclosing parts 1, 2. This recognition device can obtain input information for the further preparation of a beverage from the recognised or identified pod.
simultaneously the downstream end 42a of the stopper becomes engaged in a slot 644 designed through the bottom 643 of the holder. This engagement is going to enable the automatic driving of the pod holder 6 to its final downwards position between the two enclosing parts 1, 2 as explained bellow.

In FIGS. 5C:
the user starts moving the handle 8 to its closed position as illustrated by arrow B.
due to the system 81 of interrelated knew levers between the handle 8 and the carrier 24 of the upstream enclosing part 2, this upstream part starts moving in direction of the downstream part 1 as illustrated by arrow C. In this preferred illustrated embodiment, the downstream pod enclosing part 2 is moving too in direction of the upstream part as illustrated by arrow G.
the upstream end 42b of the holder stopper is connected to this movable carrier 24: its upstream end 42b is engaged in a slot 241 of the carrier. Accordingly, since the stopper is engaged in the slot 644 of the pod holder 6, the own movement of the carrier 24 induces simultaneously the movement of the stopper 42. The slots 644, 241 in the pod holder 6 and in the carrier 24 respectively are designed so that the movement of the upstream pod enclosing part 2 to the downstream pod enclosing part, that is the closure of the extraction chamber, induces the downwards movement of the pod holder between these two enclosing parts 1, 2 before these two parts form the extraction chamber.

When the handle reaches the position illustrated in above FIG. 4A:
the handle 8 goes on closing and the carrier 24 of the upstream enclosing part 1 goes on moving to the downstream part 1 in order to close the extraction chamber,
but the pod holder 6 stops sliding down due to the design of the slot 241 that is followed by the upstream end 42b of the stopper in the carrier. At this step of closure of the handle 8, the pod holder 6 is well aligned between the two enclosing parts 1, 2 and along the longitudinal axis XX′.

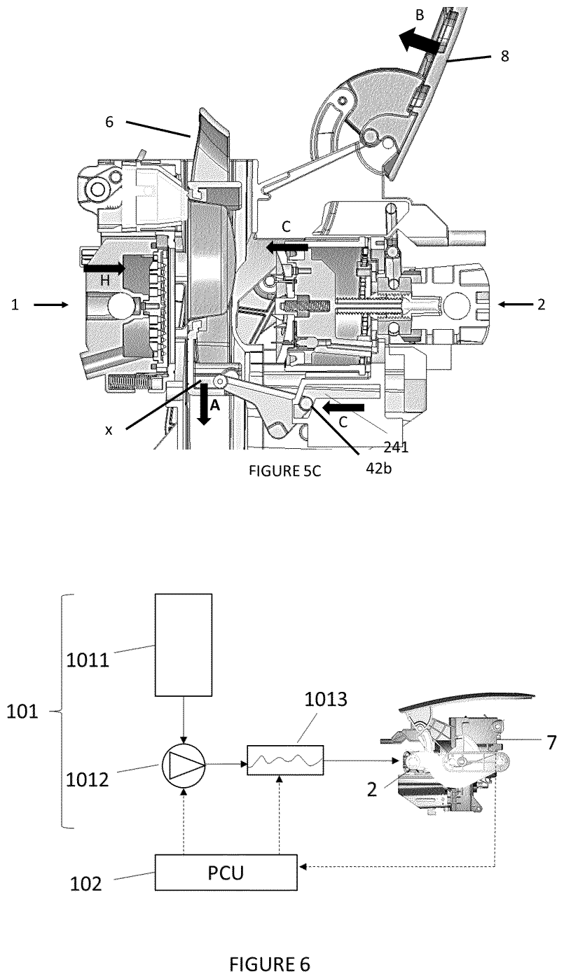

FIG. 6 illustrates the fluid system 101 of a beverage machine comprising the extraction device and configured to supply the upstream enclosing part 2 with liquid. This system 101 can comprise a tank 1011 of fluid, generally water, a pump 1012 to pump that fluid form the tank and at least one device to adapt the temperature of the fluid like a heater 1013 and/or a cooler before the fluid is dispensed to the upstream part 2.

A process control unit of the beverage machine 102 is configured to control the pump and the heater once a beverage is ordered.

This unit 102 can be used to control other controllable devices like the recognition device 7 or a display if present.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

List of references in the drawings:

| | |
|---|---|
| beverage device | 10 |
| downstream enclosing part | 1 |
| downstream plate piercing arrangement | 12 |
| spikes | 121 |
| peripheral area | 13 |
| upstream enclosing part | 2 |
| cage | 21 |
| side wall | 211 |
| back end | 213 |
| front end | 214 |
| end wall | 22 |
| front face | 22a |
| back face | 22b |
| piercing elements | 222 |
| liquid outlets | 223 |
| rod | 224 |
| teeth | 2241 |
| pin | 225 |
| spring | 2251 |
| liquid inlet | 226 |
| projection | 227 |
| jaw | 23 |
| teeth | 231 |
| spring | 232 |
| support | 233 |
| carrier | 24 |
| knee lever | 25 |
| knee lever spring | 251 |
| knee lever end | 252 |
| seal | 26 |
| rear axis | 27 |
| pod | 3, 3′ |
| body | 31, 31′ |
| side wall | 311, 311′ |
| top end | 3111 |
| top opening | 312 |
| bottom wall | 313 |
| annular flange | 314 |
| top face | 3141 |
| bottom face | 3142 |
| lid | 32 |
| annular area | 321 |
| peripheral annular area | 322 |
| beverage ingredient | 33 |
| machine-readable code | 34 |
| insertion section | 4 |
| path | 41 |
| holder stopper | 42 |
| extraction chamber | 5 |
| removable pod holder | 6 |
| pod receiving hole | 61 |
| hole surround | 611 |
| seal | 62 |
| ridge | 621 |
| code reader | 7 |
| actuator | 8 |
| interrelated knee levers | 81 |
| chassis | 9 |
| abutment walls | 91, 92, 93 |

1. An extraction device for extracting a beverage ingredient by supplying an extraction liquid into a pod,
said pod comprising:
a pod body, said pod body comprising:
a side wall and a bottom wall defining a chamber, said chamber extending axially between the bottom and a top opening, and
a top lid closing the top opening of the pod body,
and
said device comprising:
upstream and downstream pod enclosing parts, wherein at least the upstream enclosing part is movable, along a horizontal longitudinal axis between an open position for inserting and removing the pod and a closed position for forming an extraction chamber enclosing the pod during extraction,
the upstream part defining a cage and comprising piercing elements for piercing the bottom wall of the pod and liquid outlet openings,
the downstream part defining a plate transverse to the longitudinal axis, said plate comprising a downstream plane piercing arrangement for opening the lid of the pod,
a pod holder configured to hold the pod between the upstream and downstream pod enclosing parts when these parts are in the opened position, said holder being configured to hold the lid of the pod in front of the downstream plane piercing arrangement,
wherein, in the upstream pod enclosing part, the cage comprises:
a side wall extending between an opened front end and a back end along a cage longitudinal axis, said side wall being movable between the open position and the closed position,
an end wall transverse to said longitudinal axis of the cage, said end wall presenting a front face, said front face bearing the piercing elements and the liquid outlet openings, said end wall being movable inside the side wall,
and said piercing elements rising from the surface of the front face by a piercing height,
wherein
in the opened position for inserting and removing the pod, said end wall is positioned at the opened front end of the side wall, and is freely movable in direction of the back end,
in the course of the movement of the upstream enclosing part from the opened position to the closed position, the free movement of the end wall is automatically mechanically blocked when the chamber upstream enclosing part reaches a pre-determined position.

2. An extraction device according to claim 1, wherein said pre-determined position of the upstream enclosing part is intermediate between the opened position of the upstream enclosing part and the closed position of the upstream enclosing part.

3. An extraction device according to claim 1, wherein said pre-determined position of the upstream enclosing part is defined so that, when the chamber upstream enclosing part reaches said pre-determined position, the piercing elements abut on the surface of the pod.

4. An extraction device according to claim 1, wherein the end wall comprises a rod extending from a back face said end wall, said rod being mechanically blocked when the chamber upstream enclosing part reaches the pre-determined position.

5. An extraction device according to claim 1, wherein the rod is mechanical blocked by a jaw member able to be clamped around the rod.

6. An extraction device according to claim 1, wherein the operation of clamping of the jaw member is configured to be triggered by a lever, said lever being actuated by the movement of the upstream enclosing part, that is moved by the manually actuated handle.

7. An extraction device according to claim 1, wherein the lever attached to the movable chassis of the upstream enclosing part and configured to be retained and rocked by a fixed part of the extraction device, such as the fixed chassis the extraction device.

8. An extraction device according to claim 1, wherein the front face of the end wall of the cage bears a pin extending from the surface of the front face and wherein said pin is retractable inside the end wall.

9. An extraction device according to claim 1, wherein, when the chamber upstream enclosing part reaches the pre-determined position, the distance between the two enclosing parts to form the extraction chamber corresponds to the height of the pin extending from the surface of the front face of the end wall.

10. An extraction device according to 1, wherein the device comprises:
a removable pod holder, said holder comprising a pod receiving hole to receive and hold the pod,
a top insertion section configured for introducing the pod holder in the device, said top insertion section comprising a path for guiding the pod holder to the extraction area between the enclosing parts and for positioning the lid of the pod in front of the downstream enclosing part, and
wherein in the closed position of the upstream and downstream pod enclosing parts, said parts enclose the pod holder.

11. Extraction device according to claim 1, wherein the top insertion section comprises a path for guiding the pod holder to the extraction area between the upstream and downstream pod enclosing parts, and
wherein said extraction device comprises a holder stopper to stop the pod holder in an intermediate temporary position inside said path.

12. Extraction device according to claim 9, wherein the beverage device comprises an actuator to move the pod holder to the extraction area between the upstream and downstream pod enclosing parts.

13. Extraction device according to claim 1, wherein said actuator is cinematically linked to:
the holder stopper so that said stopper is configured to drive the pod holder between the intermediate position and the extraction area when said actuator is operated, and
to at least the upstream enclosing part between to move said part between the open position and the closed position of said parts.

14. (canceled)

15. System comprising an extraction device for extracting a beverage ingredient by supplying an extraction liquid into a pod,
said pod comprising:
a pod body, said pod body comprising:
a side wall and a bottom wall defining a chamber, said chamber extending axially between the bottom and a top opening, and
a top lid closing the top opening of the pod body,
and
said device comprising:
upstream and downstream pod enclosing parts, wherein at least the upstream enclosing part is movable, along a horizontal longitudinal axis between an open position for inserting and removing the pod and a closed position for forming an extraction chamber enclosing the pod during extraction,
the upstream part defining a cage and comprising piercing elements for piercing the bottom wall of the pod and liquid outlet openings,
the downstream part defining a plate transverse to the longitudinal axis, said plate comprising a downstream plane piercing arrangement for opening the lid of the pod,
a pod holder configured to hold the pod between the upstream and downstream pod enclosing parts when these parts are in the opened position, said holder being configured to hold the lid of the pod in front of the downstream plane piercing arrangement,
wherein, in the upstream pod enclosing part, the cage comprises:
a side wall extending between an opened front end and a back end along a cage longitudinal axis, said side wall being movable between the open position and the closed position,
an end wall transverse to said longitudinal axis of the cage, said end wall presenting a front face, said front face bearing the piercing elements and the liquid outlet openings, said end wall being movable inside the side wall,
and said piercing elements rising from the surface of the front face by a piercing height,
wherein
in the opened position for inserting and removing the pod, said end wall is positioned at the opened front end of the side wall, and is freely movable in direction of the back end,
in the course of the movement of the upstream enclosing part from the opened position to the closed position, the free movement of the end wall is automatically mechanically blocked when the chamber upstream enclosing part reaches a pre-determined position and pods of different depth sizes,
wherein each of said pod comprises:
a pod body, said pod body comprising a side wall and a bottom wall defining a chamber, and
a top lid closing the top opening of the pod body, and
wherein said pods differ by the depth sizes of the side walls.

16. (canceled)
